(19) United States
(12) Patent Application Publication
(10) Pub. No.: US 2026/0228791 A1
(43) Pub. Date: Aug. 6, 2026

(54) SYSTEMS AND METHODS FOR PROVIDING PRODUCT SEARCH RESULTS

(71) Applicant: Walmart Apollo, LLC, Bentonville, AR (US)

(72) Inventors: Jon Alferness, San Francisco, CA (US); Andrew J. Grignon, Roseville, CA (US); Darrell Whitelaw, Pacific Palisades, CA (US); Steven Duval Ruilova, Solana Beach, CA (US); Matthew S. Brown, Kinnelon, NJ (US); Stephen Hadinger, Berkeley, CA (US); Gabriel H. Giraldo-Wingler, Doylestown, PA (US); Tushar P. Dadlani, San Francisco, CA (US)

(21) Appl. No.: 19/042,116

(22) Filed: Jan. 31, 2025

(51) Int. Cl. G06Q 30/0601; G06F 16/9038

(52) U.S. Cl. CPC G06Q 30/0625; G06F 16/9038

(57) ABSTRACT

In some embodiments, apparatuses and methods are provided herein useful to provide product search results. In some embodiments, a system includes a communication interface to provide a search interface of a user interface to a plurality of user devices, a computer readable storage memory storing a product database and a set of computer executable instructions, and a control circuit to execute the set of computer executable instructions, causing the control circuit to: provide the search interface including a plurality of search modality options, receive a first query in a first modality from the search interface, generate, via a language model, a product results list based on the first query and the product database, receive a second query in a second modality from the search interface; and update, via the language model, the product results list based on the first query, the second query, and the product database.

### TECHNICAL FIELD

This disclosure relates generally to e-commerce retailers, and, more specifically, to search queries.

### BACKGROUND

E-commerce retailers generally have interfaces (e.g., application and websites) on which a user can navigate to interact with (e.g., view, add to cart, purchase, etc.) products available for purchase. In order to navigate the interface and products sold thereon, interfaces of an e-commerce retailer generally include search interfaces through which a user can enter a relevant term or phrase in order to find a listing of products related to the entered query. Current search interfaces can be limited by the number of modalities of query enterable via a search interface and often narrow search results when additional queries and/or criteria are entered. Accordingly, there is a need for improved search interfaces on e-commerce retailer interfaces.

### BRIEF DESCRIPTION OF DRAWINGS

Disclosed herein are embodiments of systems, apparatuses and methods pertaining to systems and methods for providing product search results. This description includes drawings, wherein:

FIG. 1 is a block diagram of a search query system in accordance with some embodiments.

FIG. 2 is a block diagram of a search query system in accordance with several embodiments.

FIG. 3 is a block diagram of a search query system in accordance with some embodiments.

FIG. 4 is a block diagram of a search query system in accordance with several embodiments.

FIG. 5 is a block diagram of a search query system in accordance with some embodiments.

FIG. 6 is a block diagram of a search query system in accordance with several embodiments.

FIG. 7 is a block diagram of a search query system in accordance with some embodiments.

FIG. 8 is a block diagram of a search query system in accordance with several embodiments.

FIG. 9 is a block diagram of a search query system in accordance with some embodiments.

FIG. 10 is a block diagram of a search query system in accordance with several embodiments.

FIG. 11 is a flow diagram of a method for providing search results in accordance with some embodiments.

FIG. 12 is a flow diagram of a method for providing search results in accordance with several embodiments.

FIG. 13 is a flow diagram of a method for providing search results in accordance with some embodiments.

FIG. 14 is a flow diagram of a method for providing search results in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to provide product search results. In some embodiments, a system for providing product search results may include a communication interface configured to provide, via a network, a search interface of a user interface to a plurality of user devices. The system may further include a computer readable storage memory storing a product database and a set of computer executable instructions. The product database may comprise a plurality of product records each associated with a set of search vectors. A control circuit may be configured to execute the set of computer executable instructions, which may cause the control circuit to provide the search interface including a plurality of search modality options. The plurality of search modality options may include at least two of a text search, an image search, a video search, an audio search, a barcode search, a color search, or a URL search. The control circuit may receive a first query in a first modality of the plurality of search modality options from the search interface, and may generate, via a language model, a product results list based on the first query and the product database. The control circuit may receive a second query in a second modality of the plurality of search modality options from the search interface, and may update, via the language model, the product results list based on the first query, the second query, and the product database.

In some embodiments, a method for providing product search results may include providing, by a communication interface via a network, a search interface of a user interface to a plurality of user devices. The method may further include storing, on a computer readable storage memory, a product database and a set of computer executable instructions. The product database may include a plurality of product records each associated with a set of search vectors. The method may further include executing the set of computer executable instructions, and providing the search interface including a plurality of search modality options. The plurality of search modality options may include at least two of a text search, an image search, a video search, an audio search, a barcode search, a color search, or a URL search. The method may further include receiving a first query in a first modality of the plurality of search modality options from the search interface, generating, via a language model, a product results list based on the first query and the product database, receiving a second query in a second modality of the plurality of search modalities from the search interface, and updating, via the language model, the product results list based on the first query and the second query.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

Conventional search query systems and platforms often use a “hub-and-spoke” model for search queries, where a user inputs a single search term and consequently needs to return to the search bar to revise and/or edit the original query. This process can be inefficient, time consuming, and limits the number of successive queries and/or type of modality of queries able to be entered by a user. The present disclosure generally describes a multi-modal user-guided recursive search query system that builds upon previous queries in generating search results rather than requiring a user to restart the query process or narrow search results. The described systems and methods generally increase modality options enterable via a search interface. Further, the systems and methods described herein infer and inject suggested variations and phrases (e.g., pivots) based on a user's original search query in order to guide a user to what they are searching for. The pivots (which are generated by the recursive search experience) generally allow for an easier, more intuitive, and more efficient shopping experience which can further adapt and evolve to a user's preferences over time.

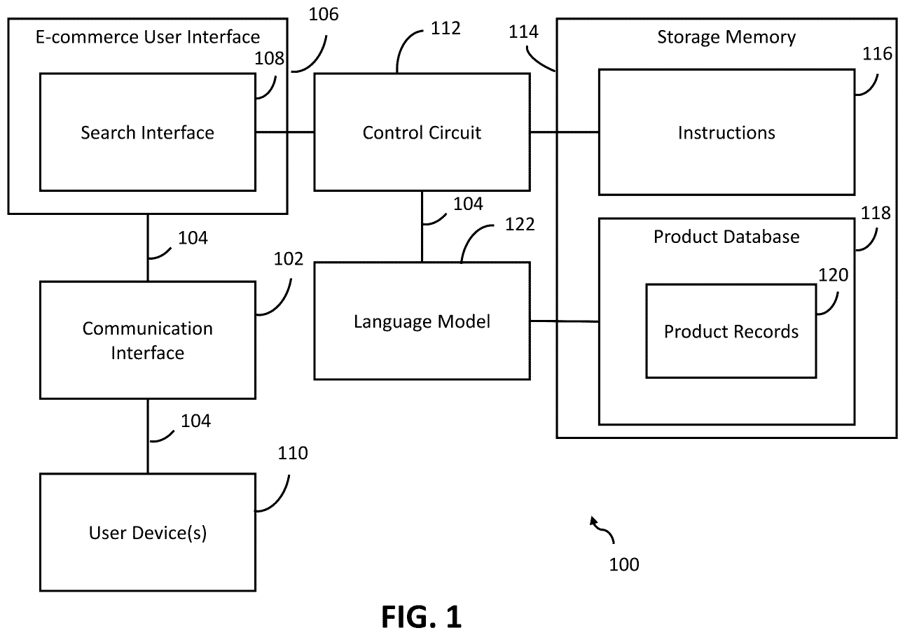

Referring to FIG. 1, a search query system 100 for providing product search results is shown in accordance with some embodiments. As shown, the search query system 100 includes a communication interface 102 that is communicatively coupled to an e-commerce user interface 106 (which may be generically referred to as a user interface) and a plurality of user devices 110 over a network 104. The search query system 100 may include a control circuit 112 communicatively coupled to the e-commerce user interface 106, a computer readable storage memory 114, and a language model 122 over the network 104. It is generally contemplated, that any of the components (i.e., the communication interface 102, the network 104, the e-commerce user interface 106, the user devices 110, the control circuit 112, the computer readable storage memory 114, and/or the language model 122) of the search query system 100 may be communicatively and/or operatively coupled to one another via the network 104.

In some embodiments, the communication interface 102 may be configured to transmit data and/or signals between two or more devices/components (e.g., devices/components of the search query system 100 and/or devices/components in communication with the search query system 100). Examples of suitable communication interfaces 102 include, but are not limited to, ports, transceivers, communication links, and so forth allowing the search query system 100 and components thereof to communicate over a communication bus, a distributed computer, and/or a network 104. In some embodiments, the communication interface 102 may be a communication bus configured to allow at least the e-commerce user interface 106 and the user devices 110 to communicate with one another. For example, the communication interface 102 may be an intermediary application programming interface (API) to provide relevant information (e.g., product information) to be displayed on the e-commerce user interface 106. In some aspects, the communication interface 102 can include a wired connection, a wireless connection, and/or a combination of wired and wireless connections.

In some embodiments, the network 104 may be any suitable network or communication method such as, for example, a local area network (LAN), the Internet, wide area network (WAN), etc., communication link, other networks or communication channels with other devices and/or other such communications (not shown) or combination of two or more of such communication methods. There may be any combination of wired connections and/or wireless connections (e.g., Wi-Fi, Bluetooth, cellular, RF, and/or other such wireless communication) between elements of the search query system 100.

The e-commerce user interface 106 may include a search interface 108 in accordance with some embodiments. In some aspects, the search interface 108 may be provided to the user devices 110 by the communication interface 102 via the network 104. In some embodiments, the e-commerce user interface 106 may be, for example, a website and/or a mobile application associated with an e-commerce retailer. Generally, the e-commerce user interface 106 may be navigable by a user to view and/or purchase products from an e-commerce retailer. In some embodiments, the e-commerce user interface 106 may be accessible via the user devices 110, such that an input made by a user via the user device 110 allows a user to navigate the e-commerce user interface 106. In one example, the e-commerce user interface 106 may be an application of an e-commerce retailer accessible on a mobile device. Example mobile devices may include, but are not limited to, cellular telephones, smartphones, tablets, portable computers, laptop computers, personal digital assistants, wearable devices, watches, eyeglasses, goggles, media players vehicle displays, and the like. In another example, the e-commerce user interface 106 may be a website of an e-commerce retailer accessible by a computer or mobile device. The e-commerce user interface 106 may allow a user to log into an account associated with the user and the e-commerce retailer, browse products for purchase, add products to a virtual cart, place orders, and so forth.

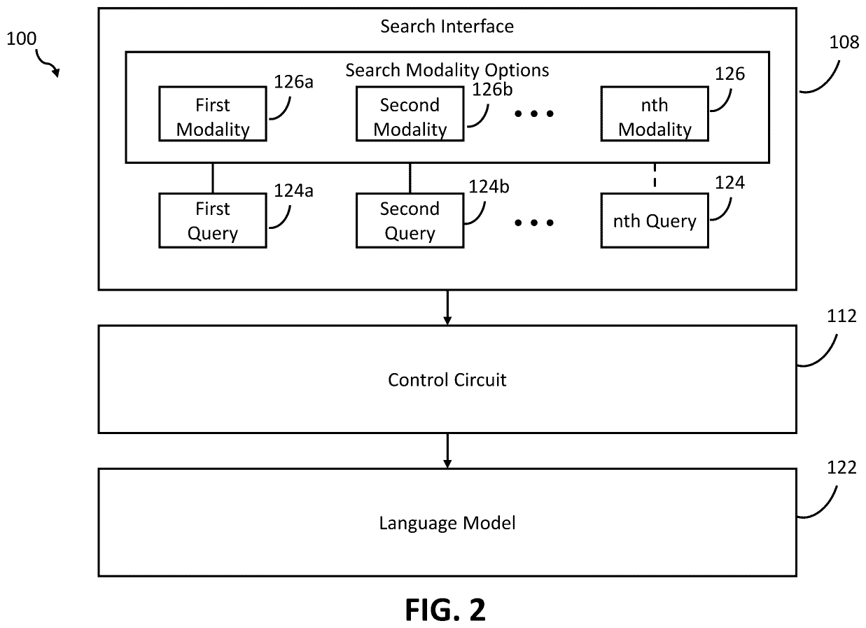

Further referring to FIG. 2, the search interface 108 may be a search platform associated with the e-commerce user interface 106 in accordance with some embodiments. For example, the search interface 108 may be a search bar and/or search screen of the e-commerce user interface 106, which a user may utilize to input search terms or parameters. Generally, the search interface 108 may be used to find products available for purchase at the e-commerce retailer relevant to one or more queries 124. Non-limiting examples of queries 124 which may be searched via the search interface 108 include, for instance, a question, product characteristic, product purpose, and the like. In some aspects, as illustrated in FIG. 2, the search interface 108 may be a multi-modal search interface 108 such that a user can enter multiple queries 124 in multiple search modalities 126. To this end, the search interface 108 may include a plurality of search modality 126 options. For example, a user searching for a coat to purchase may use their mobile phone (i.e., the user device) to select and open an application associated with the retailer (i.e., the e-commerce user interface). The user may navigate to a search screen (i.e., the search interface), which displays a search bar with multiple selectable options associated with multiple types of input (i.e., the search modalities). For example, the user may input an image of a coat similar to what they are interested in finding, a desired color of the coat, and text regarding a desired length of the coat. In response to the inputs, a listing of products may be generated including coats that look like the coat in the image that are also the desired color and length. The multiple types of input (i.e., the image, the color, and the text) may be input and utilized together in order to generate relevant search results.

In some aspects, the search modality 126 options may include at least two of a text search, an image search, a video search, an audio search, a barcode search, a color search, and/or a URL search. In some embodiments, a text search may include simple text strings in addition to broader semantic phrases. It should be understood that suitable search modality 126 options are not limited to the described modalities. Instead, it is generally contemplated that the search interface 108 may be configured to receive a query 124 in any suitable search modality 126, and that the provided examples are non-exhaustive.

In some embodiments, the user devices 110 may be operatively coupled to the any described components of the search query system 100 and may include, but are not limited to, smartphones, tablets, laptops, computers, and/or other such computing systems that enable a user to communicate with the search query system 100. In some aspects, one or more user devices 110 may be part of the search query system 100 and/or one or more user devices 110 may be separate and distinct from the search query system 100. The search query system 100 can further include and/or be in communication with one or more networks 104 and/or communication interfaces 102. The user device(s) 110 can allow a user to interact with the search query system 100 and receive information through the system. In some instances, the user device 110 includes a display and/or one or more user inputs, such as buttons, touch screen, track ball, keyboard, mouse, etc., which can be part of or wired or wirelessly coupled with the search query system 100.

The computer readable storage memory 114 may store a product database 118 and a set of computer executable instructions 116 in accordance with some embodiments. The product database 118 may include/store a plurality of product records 120 each being associated with a set of search vectors. Examples of suitable computer readable storage memory 114 includes random access memory (RAM), read-only memory (ROM), erasable programmable read-only memory (EPROM/flash memory), and so forth, and may include transient and/or non-transient mediums. The computer readable storage memory 114 typically includes one or more processor-readable and/or computer-readable media accessed by at least the control circuit 112, and can include volatile and/or nonvolatile media, such as RAM, ROM, EEPROM, flash memory and/or other memory technology. The computer readable storage memory 114, while shown as external to the control circuit 112, can be internal, external, or a combination of internal and external memory of the control circuit 112. While one computer readable storage memory 114 is shown storing both computer executable instructions 116 and the product database 118, it is generally contemplated that there may be any additional number of computer readable storage memory 114 such as, for example, a first computer readable storage memory 114 storing the computer executable instructions 116 and a second computer readable storage memory 114 storing the product database 118. In some embodiments, the product database 118 may be any suitable database (e.g., hierarchical databases, relational databases, non-relational databases, object oriented databases, and so forth) configured to store data relevant to the search query system 100. In some embodiments, the product database 118 stores data which may include product data (e.g., product characteristics, product name, product descriptions, and so forth), historical query data, product vectors, search vectors, etc.

In some embodiments, the control circuit 112 is configured to execute the computer executable instructions 116. The control circuit 112 may include any suitable processing resource configured to execute instructions (e.g., the computer executable instructions 116) stored in a computer-readable storage memory (e.g., a non-transitory, computer-readable storage medium and/or the computer readable storage memory 114). In this context, the terms control circuit 112 and controller refer broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The computer executable instructions 116 may, for example, be code, software, programming, executables, scripts, etc., executable by the control circuit 112 and/or other computing devices. The control circuit 112 or controller may be configured (for example, by using corresponding programming stored in a memory as will be well understood by those skilled in the art) to carry out one or more of the steps, actions, and/or functions described herein.

In some embodiments, the language model 122 may be any suitable trained machine learning model, including decision trees, random forest, neural networks, deep learning, and so forth. In some embodiments, the language model 122 is a large language model. In the present embodiment, the language model 122 may be operatively coupled with the control circuit 112 via the network 104, and the control circuit 112 may execute the language model 122. In some embodiments, instructions stored in memory (e.g., of the control circuit 112 and/or external memory) may cause the control circuit 112 to output information and/or data from the user device(s) 110, the product database 118, the communication interface 102, and/or the e-commerce user interface 106, to be used by the language model 122. The language model 122 is generally pre-trained with data, and in some embodiments may be re-trained by any combination of manually input re-training data and/or self-learning methods.

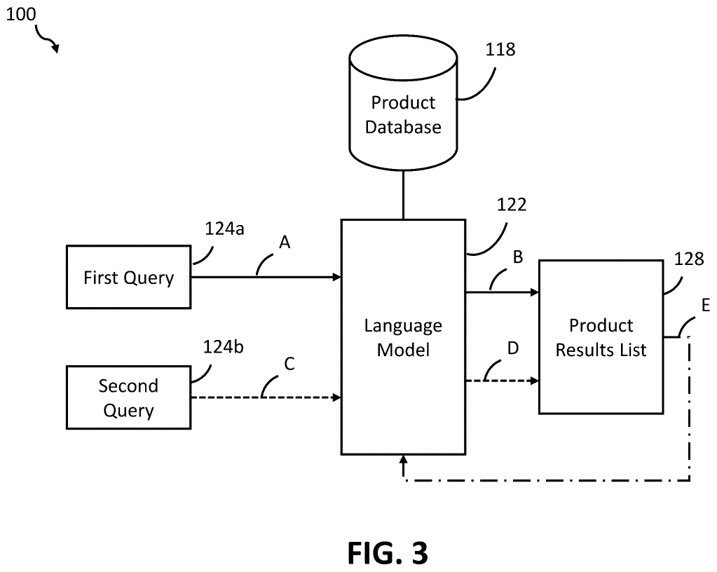

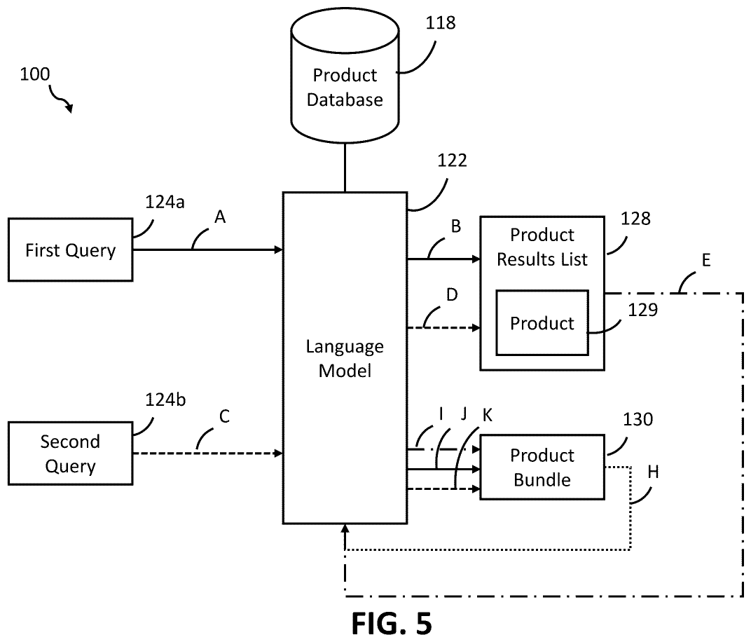

As shown in FIG. 2, any number of queries 124 may be received in any second modality 126b through the search interface 108. For example, the control circuit 112 may receive a first query 124a in a first modality 126a of the multiple search modality 126 options from the search interface 108. Further referring to FIG. 3, since the control circuit 112 and the language model 122 are communicatively coupled, the control circuit 112 may generate, via the language model 122, a product results list 128 based on at least the first query 124a and the product database 118. In other words, after receiving a query 124 from a user, the search query system 100 may generate a product results list 128 that includes at least one product 129 (as shown in FIG. 5) related to the query 124 (e.g., a text search for ‘purple toys’ would generate a product results list 128 including products 129 most relevant to ‘purple toys’). The control circuit 112 may further receive a second query 124b in a second modality 126b of the plurality of search modality 126 options from the search interface 108. The control circuit 112 updates, via the language model 122, the product results list 128 based on the first query 124a, the second query 124b, and the product database 118. In other words, the addition of a second query 124b from a user caused the search query system 100 to update the product results list 128 further taking into account the additional query 124 (e.g., an initial text search for ‘purple toys’ and an additional image search from a picture of a dinosaur would update the product results list 128 to include products 129 most relevant to ‘purple toys’ and ‘dinosaurs’). In some embodiments, multiple queries 124 are input at the same point in time (i.e., two queries 124 are received before the product results list 128 is generated) while in some aspects multiple queries 124 are input at multiple points in time (i.e., an initial query 124 is entered and a product results list 128 is generated, and a subsequent query 124 is entered and the product results list 128 is updated to include the second query 124b). Any number of queries 124 of any combination of search modalities 126 can be entered at the same point in time, and any subsequent number of queries 124 can be entered to update a product results list 128 any suitable number of times (e.g., a product results list 128 can be updates once, twice, and so forth).

In some embodiments, a query 124 may be converted to a text string or an encoded image to be input into the language model 122, regardless of the search modality 126 (i.e., the language model 122 may be a large language model or a vision language able to receive input as text or images and not alternative search modalities 126 that a user is able to enter a query 124 in). Any suitable model (e.g., machine learning and/or alternate software models) may convert any non-text and/or non-image search modalities 126 into text and/or images in accordance with some embodiments. In some embodiments, an updated product results list 128 may be narrowed relative to a previous product results list 128 (i.e., the updated product results list 128 includes a subset of products 129 from the products in the product results list 128), while in some aspects an updated product results list 128 may be pivoted from the product results list 128 (i.e., the subset of products 129 in the updated product results list 128 can include products within a previous subset of products 129 in the product results list 128 and products 129 not in a previous subset of products 129 in the product results list 128). Generally, the product results list 128 may be output for display on the e-commerce user interface 106 such that a user is able to view and navigate products 129 relevant to the queries 124.

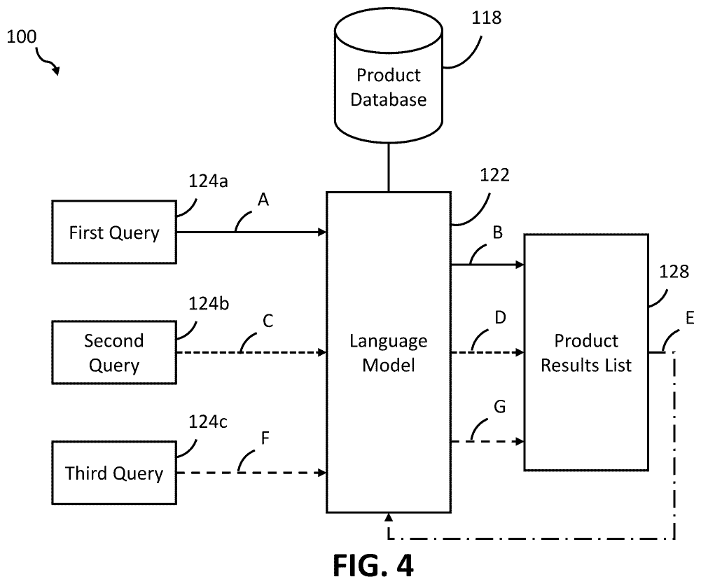

Referring to FIG. 3, the solid line A represents the first query 124a being received by the language model 122, and the solid line B represents the product results list 128 being generated by language model 122 based on the first query 124a. The dashed line C represents the second query 124b being received by the language model 122, and the dashed line D represents the product results list 128 being updated/generated by the language model 122 based on the second query 124b. The broken line E represents the product results list 128 being used by the language model 122 in embodiments where the product results list 128 is being updated and not generated. Generally, when the product results list 128 is generated and/or updated, data stored in the product database 118 is used by the language model 122. While two queries 124 are shown, it is generally contemplated that any suitable number of queries 124 may be used to generate and/or update the product results list 128. For example, further referring to FIG. 4, the search query system 100 may further include a third query 124c received by the control circuit 112 from the search interface 108 (not shown), and the control circuit 112 may further update, via the language model 122, the product results list 128 based on the first query 124a, the second query 124b, and the third query 124c. The dashed line F in FIG. 4 represents the third query 124c being received by the language model 122, and the dashed line G represents the product results list 128 being updated/generated by the language model 122 based on the third query 124c.

Further referring to FIG. 5, the search query system 100 may further include the generation of a product bundle 130 in accordance with some embodiments. In some aspects, the control circuit 112 may further select a product 129 from the product results list 128, and may generate, via the language model 122, a product bundle 130 based on attributes associated with the product 129. In some embodiments, the control circuit 112 may cause the product bundle 130 to be displayed with the product 129 on the e-commerce user interface 106. Generally, the product bundle 130 may be a grouping of the selected product 129 and at least one related product 129 (e.g., chips and dip). In some embodiments, the related product(s) 129 in the product bundle 130 are not included in the product results list 128, while in some aspects the related product(s) 129 in the product bundle 130 are included in the product results list 128. The product 129 selected for generation of the product bundle 130 may be selected randomly, by the user, based on historical queries of the user, based on the product 129 in the product results list 128 being historically purchased with the additional product(s) 129 in the product bundle 130, and so forth. The broken line I represents the product bundle 130 being generated by the language model 122 based on (at least in part) by the product results list 128 (e.g., the selection of the product 129 from the product results list 128). In some embodiments, the product bundle 130 may be further generated based on the first query 124a, and the solid line J represents the product bundle 130 being generated by the language model 122 based on the first query 124a. In some embodiments, the control circuit 112 may update the product bundle 130 based on the first query 124a and the second query 124b in response to receiving the second query 124b. Similarly to the updating and generating of the product results list 128, a product bundle 130 may be generated based on any number of queries 124 in any number of search modalities 126 and may be updated based on any additional queries 124. The solid line J in FIG. 5 represents the product bundle 130 being generated by the language model 122 based on the first query 124a, and the dashed line K represents the product bundle 130 being updated and/or generated by the language model 122 based on the second query 124b. The dashed line H indicates the product bundle 130 being received by the language model 122 and used to update the product bundle 130.

While the present embodiments describe the product bundle 130 as being generated in response to product(s) 129 of product results list 128 being selected, it is generally contemplated that the product bundle 130 may be generated independent of the product results list 128, and that products 129 in the product results list 128 being associated with a product bundle 130 may cause the product bundle 130 to be displayed to the user via the e-commerce user interface 106. There may be any suitable number of product bundles 130 generated, updated, and/or displayed relative to the receival of at least one query 124. In some embodiments, the selection of a product bundle 130 by a user may further update the product results list 128.

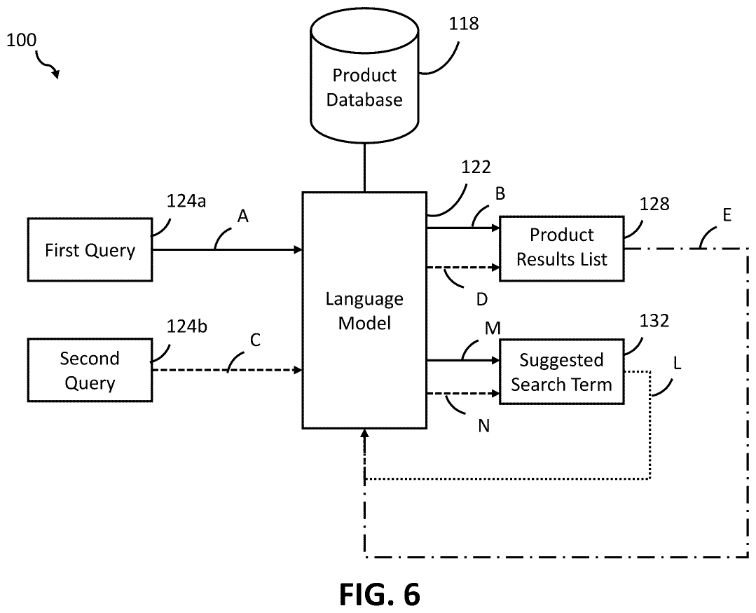

Further referring to FIG. 6, the search query system 100 may further include the generation of a suggested search term 132 in accordance with some embodiments. A suggested search term 132 is generally a term related to the current queries 124 that may be used to further refine the product results list 128. For example, a series of queries 124 related to ‘kitchen remodeling’ may generate a suggested search term of ‘tiling’ or ‘wallpaper’. In some aspects, the control circuit 112 may further generate, via the language model 122, a suggested search term 132 based on the first query 124a and the product database 118. As an example, the solid line M in FIG. 6 represents the first query 124a being used by the language model 122 to generate the suggested search term 132. The control circuit 112 can further update, via the language model 122, the suggested search term 132 based a receival of the second query 124b. The dashed line N represents the second query 124b being used to update and/or generate the suggested search term 132. In other words, the suggested search term 132 is related (in the present example) to the first query 124a or to the first query 124a and the second query 124b. It is generally understood that the suggested search term 132 may be generated based on any number of initial queries 124 in any combination of multiple search modalities 126, and updated by any subsequent queries 124 such that the updates suggested search term 132 is relevant to the initial query 124 and the subsequent queries 124. The dashed line L represents the suggested search term 132 being received by the language model 122 and used to update the suggested search term 132. In some aspects (not shown), the control circuit 112 may update, via the language model 122, the product results list 128 based on a selected suggested search term 132.

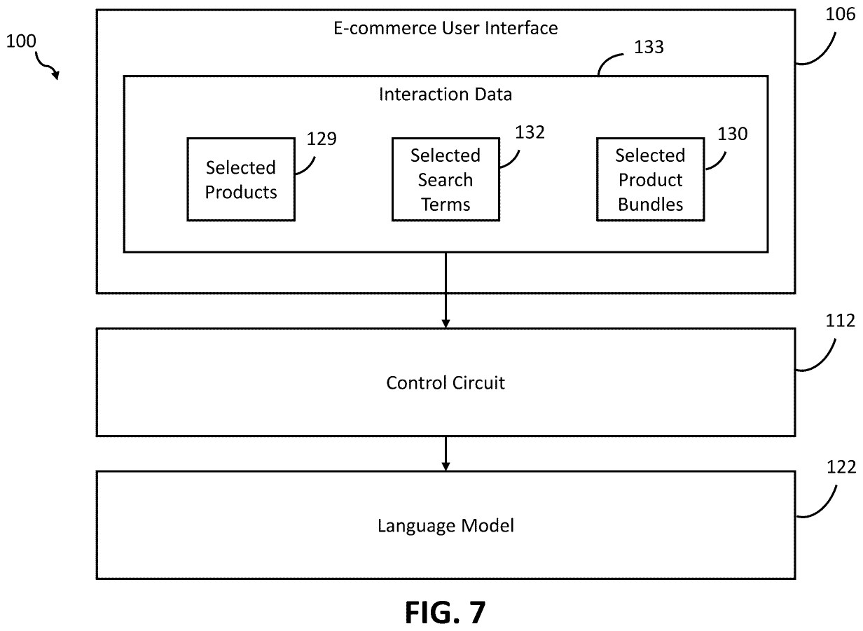

Further referring to FIG. 7, the search query system 100 may further include updating the language model 122 in accordance with some embodiments. In some aspects, the control circuit 112 may update the language model 122 based on interaction data 133 received via the e-commerce user interface 106. In some embodiments, the interaction data 133 may include at least one of the selected products 129 from the product results list 128, selected suggested search terms 132, or selected product bundles 130. In other words, the language model 122 may be updated based on user input that is indicative of user preferences, and the language model 122 may learn what products in the product results list 128 may be most relevant to a user's preferences. The interaction data 133 may, in some embodiments, include any alternate and/or additional input received by at the e-commerce user interface 106 (e.g., order history, cart history, fulfillment preferences, and so forth).

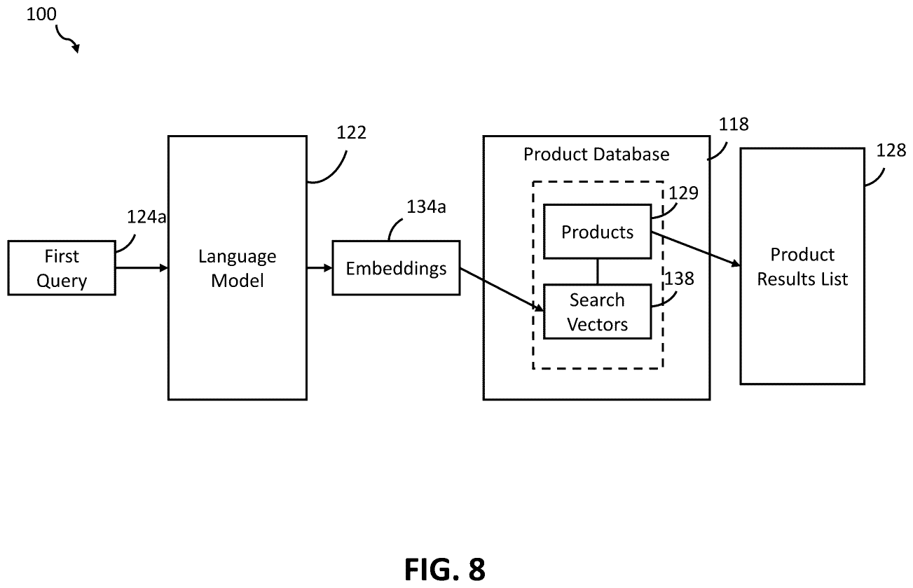

Further referring to FIG. 8, the search query system 100 is shown in accordance with some embodiments. In some aspects, the generation of the product results list 128 may further include receiving embeddings 134a associated with the first query 124a from the language model 122, and identifying a plurality of products 129 from the plurality of product records 120 stored in the product database 118 by matching the embeddings 134a associated with the first query 124a with search vectors 138 associated with products 129 in the product database 118. It is generally contemplated that embeddings 134 are generated for any number of respective queries 124.

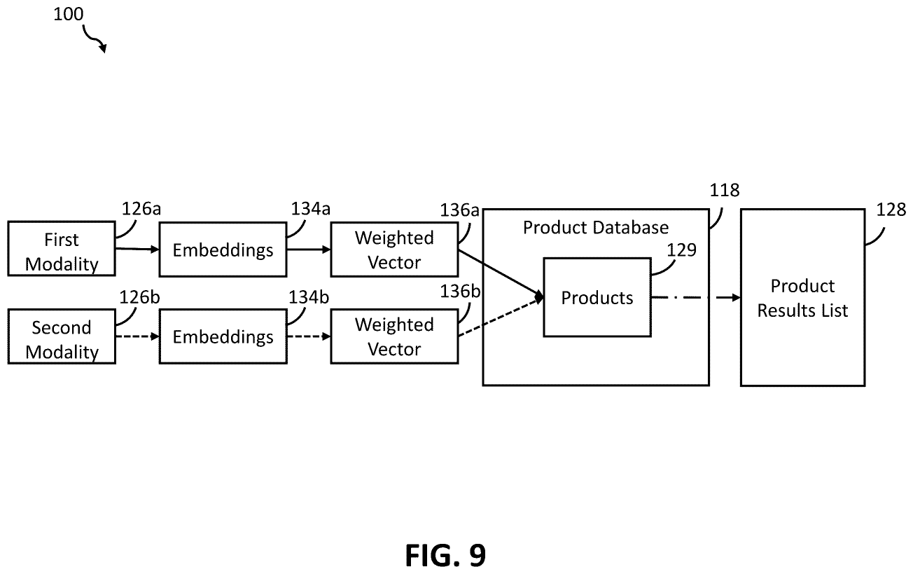

Further referring to FIG. 9, the search query system 100 is shown in accordance with some embodiments. The product results list 128 may be updated by weighting the embeddings 134a associated with the first modality 126a with a first weighted vector 136a, and weighting embeddings 134b associated with the second modality 126b with a second weighted vector 136b. Further, products 129 in the product database 118 may be identified based on the weighted vectors 136a, 136b of the embeddings 134a, 134b associated with the first modality 126a and the second modality 126b. For example, in some embodiments, each search modality 126 (e.g., text, image, color, etc.) may receive an equal weighted vector 136 such that in generating the product results list 128 each query 124 is equally considered regardless of the search modality 126. In another example, in some embodiments, at least two search modalities 126 may receive differently weighted vectors 136 such that in generating the product results list 128 a query 124 in a first search modality 126 is more highly considered than a query 124 in a second search modality 126. In some forms, each search modality 126 may be associated with a respective weighted vector 136. In some embodiments, an aggregation of each weighted vector 136 is equivalent to 100% (i.e., 1), while in some aspects, each weighted vector has a value up to 100% (i.e., between 0.0 and 1.0). While a weighting scale of one is described, any alternate suitable weighting scales may be used (either for an individual weighted vector 136 and/or for an aggregate of all weighted vectors 136). In some embodiments, the search modalities 126 may be pre-weighted (e.g., by the retailer), while in some aspects a user may be able to alter the weight of specific search modalities 126 (e.g., in a settings category of the e-commerce user interface 106, a filter on the search interface 108, etc.). It is generally contemplated that any suitable embeddings model known in the art may be used to embed and/or weight the queries 124 and/or search modalities 126.

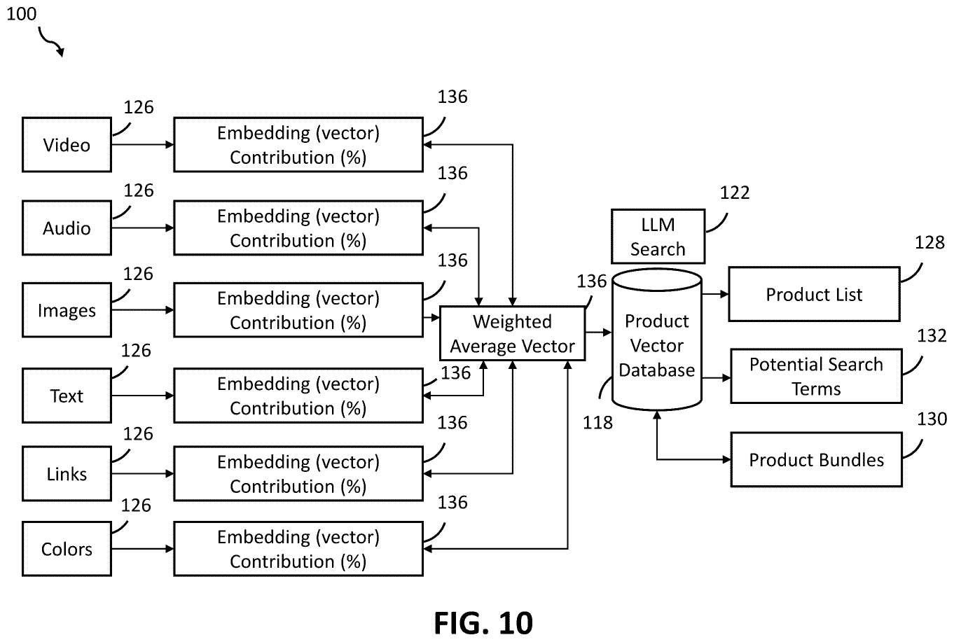

Further referring to FIG. 10, a block diagram of the search query system 100 is shown with various example search modalities 126 (e.g., audio, images, text, links, colors, etc.), each associated with a respective weighted vector 136 (e.g., an embedding vector with a contribution percentage) contributing towards an aggregate/average weighted vector 136 (i.e., where the contribution percentage of each individual weighted vector 136 is relative to 100% and/or the weighted average vector). As shown, the product database 118 (e.g., the product vector database) and the language model 122 (e.g., via an LLM search) may generate the product results list 128, the suggested search term 132, and/or the product bundle 130.

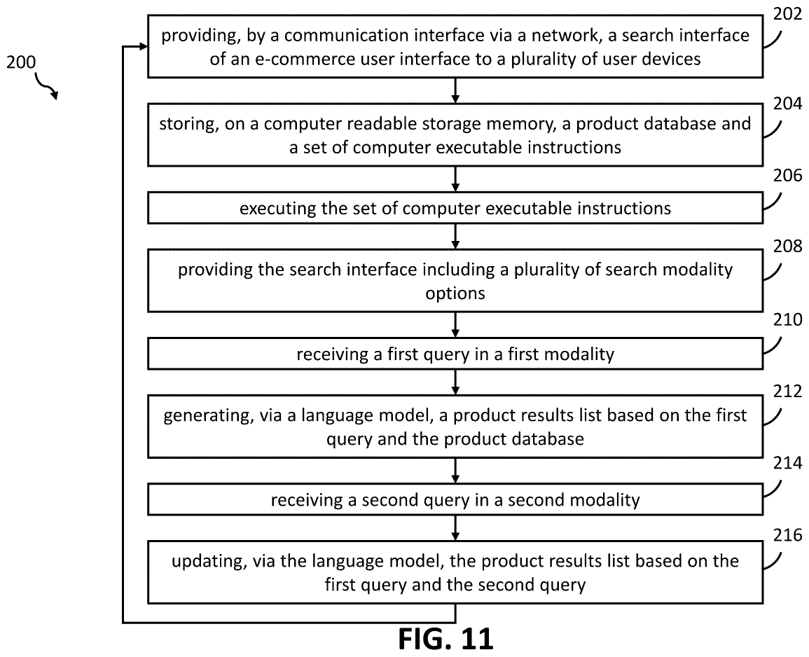

FIGS. 11-14 show a method 200 for providing search results in accordance with some embodiments. Generally, the method 200 may be implemented by the search query system 100 and/or components of the search query system 100 described herein. Referring to FIG. 11, the method 200 includes a step 202 of providing, by a communication interface via a network, a search interface of an e-commerce user interface to a plurality of user devices. At step 204, the method 200 includes storing, on a computer readable storage medium, a product database and set of computer executable instructions. In some embodiments, the product database includes a plurality of product records each associated with a set of search vectors. At step 206, the method 200 includes executing the step of computer executable instructions. The instructions are generally executed by a processor-based device and/or processing resource.

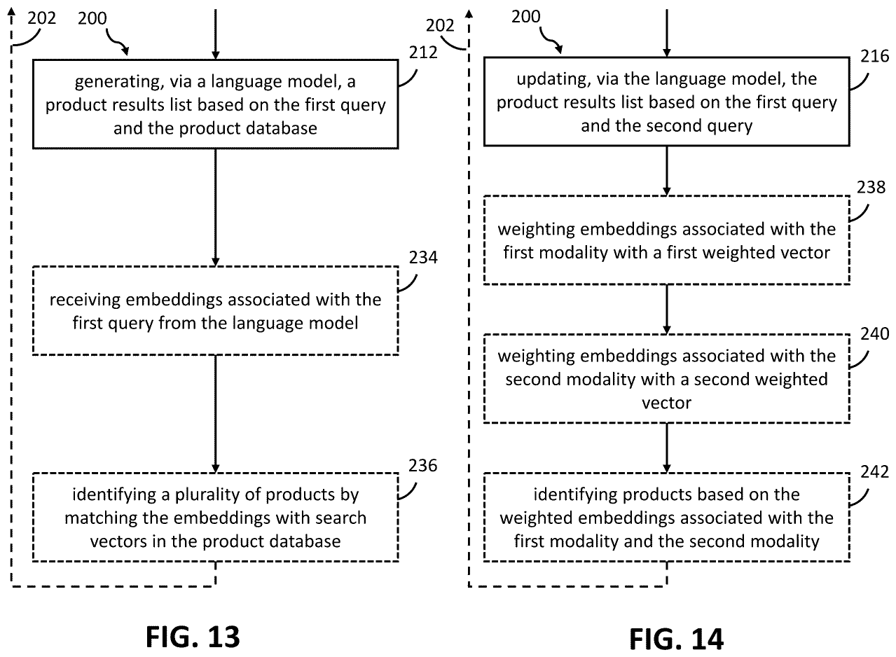

The proceeding steps are generally in response to the execution of the computer executable instructions at step 206. At step 208, the method 200 includes providing the search interface including a plurality of search modality options. Generally, the plurality of search modality options may include at least two of a text search, an image search, a video search, an audio search, a barcode search, a color search, or a URL search. In other words, the search interface is a multi-modal search interface allowing a user to search in multiple modalities. At step 210, the method 200 further includes receiving a first query in a first modality of the plurality of search modalities from the search interface, and at step 212 the method 200 includes generating, via a language model, a product results list based on the first query and the product database. In further embodiments (as shown in FIG. 13), step 212 further includes a step 234 of receiving embeddings associated with the first query from the language model, and a step 236 of identifying a plurality of products from the plurality of product records by matching the embeddings associated with the first query with search vectors associated with products in the product database.

Referring back to FIG. 11, method 200 further includes a step 214 of receiving a second query in a second modality of the plurality of search modality options from the search interface, and a step 216 of updating, via the language model, the product results list based on the first query and the second query. In further embodiments (as shown in FIG. 14), step 216 further includes a step 238 of weighting embeddings associated with the first modality with a first weighted vector, a step 240 of weighting embeddings associated with the second modality with a second weighted vector, and a step 242 of identifying products in the product database based on the weighted embeddings associated with the first modality and the second modality.

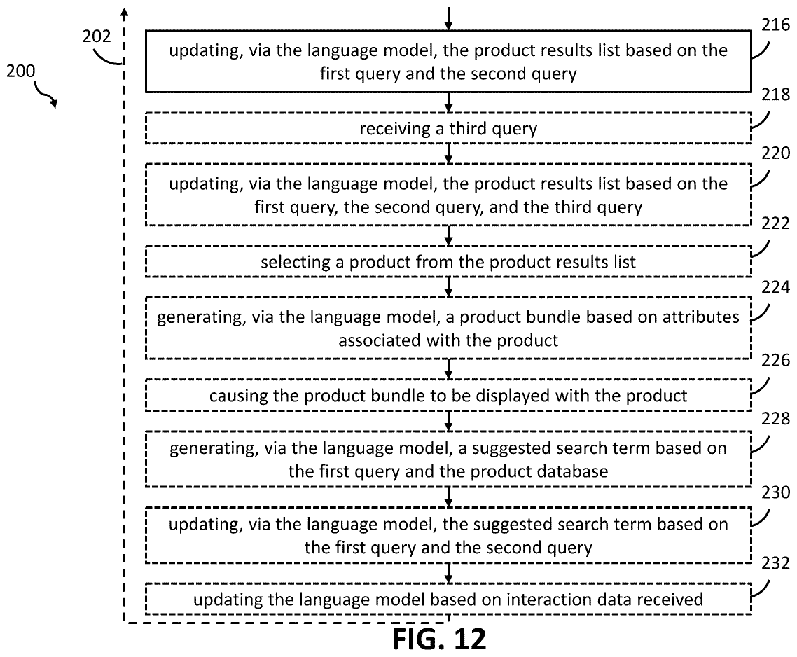

Now referring to FIG. 12, the method 200 may further include any of the following optional steps 218, 220, 222, 224, 226, 228, 230, 232. Proceeding step 216, the method 200 may further include a step 218 of receiving a third query from the search interface, and a step 220 of further updating, via the language model, the product results list based on the first query, the second query, and the third query. The method 200 may further include a step 222 of selecting a product from the product results list, a step 224 of generating, via the language model, a product bundle based on attributes associated with the product, and a step 226 of causing the product bundle to be displayed with the product on the e-commerce user interface. The method 200 may further include a step 228 of generating, via the language model, a suggested search term based on the first query and the product database, and step 230 of updating, via the language model, the suggested search term based on the first and the second query. The suggested search term may be related to the first query or to the first query and the second query. The method 200 may further include a step 232 of updating the language based on interaction received via the e-commerce user interface.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system for providing product search results, the system comprising:
a communication interface configured to provide, via a network, a search interface of a user interface to a plurality of user devices;
a computer readable storage memory storing a product database and a set of computer executable instructions, wherein the product database comprises a plurality of product records each associated with a set of search vectors; and
a control circuit configured to execute the set of computer executable instructions, which causes the control circuit to:
provide the search interface including a plurality of search modality options, wherein the plurality of search modality options comprises at least two of a text search, an image search, a video search, an audio search, a barcode search, a color search, or a URL search;
receive a first query in a first modality of the plurality of search modality options from the search interface;
generate, via a language model, a product results list based on the first query and the product database;
receive a second query in a second modality of the plurality of search modality options from the search interface; and
update, via the language model, the product results list based on the first query, the second query, and the product database.

2. The system of claim 1, wherein generating the product results list comprises:
receiving embeddings associated with the first query from the language model; and
identifying a plurality of products from the plurality of product records by matching the embeddings associated with the first query with search vectors associated with products in the product database.

3. The system of claim 1, wherein the first query is converted to a text string or an encoded image as input to the language model.

4. The system of claim 1, wherein the language model comprises a large language model.

5. The system of claim 1, wherein the product results list is updated based on:
weighting embeddings associated with the first modality with a first weighted vector;
weighting embeddings associated with the second modality with a second weighted vector; and
identifying products in the product database based on the weighted embeddings associated with the first modality and the second modality.

6. The system of claim 1, wherein the control circuit further:
receives a third query from the search interface; and
further updates, via the language model, the product results list based on the first query, the second query, and the third query.

7. The system of claim 1, wherein the control circuit further:
selects a product from the product results list;
generates, via the language model, a product bundle based on attributes associated with the product; and
causes the product bundle to be displayed with the product on the user interface.

8. The system of claim 7, wherein the product bundle is further generated based on the first query.

9. The system of claim 7, wherein the control circuit further:
updates the product bundle, via the language model, based on the first query and the second query in response to receiving the second query.

10. The system of claim 1, wherein the control circuit:
generates, via the language model, a suggested search term based on the first query and the product database; and
updates, via the language model, the suggested search term based on the first query and the second query;
wherein the suggested search term is related to the first query or to the first query and the second query.

11. The system of claim 10, wherein the control circuit:
updates, via the language model, the product results list based on a selected suggested search term.

12. The system of claim 1, wherein the control circuit further:
updates the language model based on interaction data received via the user interface.

13. The system of claim 12, wherein the interaction data comprises at least one of selected products from the product results list, selected suggested search terms, or selected product bundles.

14. A method for providing product search results, the method comprising:
providing, by a communication interface via a network, a search interface of a user interface to a plurality of user devices;
storing, on a computer readable storage memory, a product database and a set of computer executable instructions, wherein the product database comprises a plurality of product records each associated with a set of search vectors;
executing the set of computer executable instructions;
providing the search interface including a plurality of search modality options, wherein the plurality of search modality options comprises at least two of a text search, an image search, a video search, an audio search, a barcode search, a color search, or a URL search;
receiving a first query in a first modality of the plurality of search modality options from the search interface;
generating, via a language model, a product results list based on the first query and the product database;
receiving a second query in a second modality of the plurality of search modality options from the search interface; and
updating, via the language model, the product results list based on the first query and the second query.

15. The method of claim 14, wherein the generating the product results list comprises:
receiving embeddings associated with the first query from the language model; and
identifying a plurality of products from the plurality of product records by matching the embeddings associated with the first query with search vectors associated with products in the product database.

16. The method of claim 14, wherein the updating the product results list is based on:
weighting embeddings associated with the first modality with a first weighted vector;
weighting embeddings associated with the second modality with a second weighted vector; and
identifying products in the product database based on the weighted embeddings associated with the first modality and the second modality.

17. The method of claim 14, further comprising:
receiving a third query from the search interface; and
further updating, via the language model, the product results list based on the first query, the second query, and the third query.

18. The method of claim 14, further comprising:
selecting a product from the product results list;
generating, via the language model, a product bundle based on attributes associated with the product; and
causing the product bundle to be displayed with the product on the user interface.

19. The method of claim 14, further comprising:
generating, via the language model, a suggested search term based on the first query and the product database; and
updating, via the language model, the suggested search term based on the first query and the second query;
wherein the suggested search term is related to the first query or to the first query and the second query.

20. The method of claim 14, further comprising:
updating the language model based on interaction data received via the user interface.
